(19) United States
(12) Patent Application Publication
(10) Pub. No.: US 2024/0092338 A1
(43) Pub. Date: Mar. 21, 2024

(54) Method for Controlling Two or More Comfort Functions of a Vehicle and Vehicle Device

(71) Applicant: Gentherm Präzision SE, Treuchtlingen (DE)

(72) Inventors: Erich Dörfler, Treuchtlingen (DE); Jürgen Baumgartl, Treuchtlingen (DE)

(21) Appl. No.: 18/467,226

(22) Filed: Sep. 14, 2023

(30) Foreign Application Priority Data
Sep. 16, 2022 (DE) 10 2022 123 847.4

(51) Int. Cl. B60W 10/30; B60H 3/00; B60N 2/56; B60N 2/90

(52) U.S. Cl. CPC B60W 10/30; B60H 3/0007; B60H 3/0078; B60N 2/5621; B60N 2/914; B60N 2/976; B60W 2710/30

(57) ABSTRACT

A method for controlling two or more comfort functions of a vehicle uses a controller, wherein a first comfort function is provided by a pneumatic massage system of a vehicle seat including one or more air cushions and an air supply system for individual air impingement of the one or more air cushions, and wherein a second comfort function is provided by an electromechanical vibration system of the vehicle seat independent from the pneumatic massage system and including one or more individually controllable electromechanical vibration devices. The method includes: analyzing a provided audio or video file taking the provided comfort functions into account; orchestrating the audio or video file by generating individual control signals for each comfort function the audio or video file after the analyzing; and synchronized transmitting the individual control signals to the corresponding comfort functions, whereby each comfort function is controlled by an individually assigned one of the individual control signals.

### TECHNICAL FIELD

The disclosure pertains to a method for controlling two or more comfort functions of a vehicle by means of a controller and vehicle equipment to carry out the method.

### BACKGROUND

Massage systems in vehicle seats are known, in particular, as the comfort function of a vehicle. Such massage systems use air cushions in the seat structure that are filled and vented in cycles. Here, smaller air cushions serve especially for selective massage, larger air cushions serve especially for repositioning the body of a person sitting on the seat.

It is furthermore known that mechanical systems are arranged in the vehicle seat with electromechanical vibration elements. For example, motors are used as electromechanical vibration elements.

It is known from DE 10 2016 217 354 A1 that a vibration massage unit consisting of an electric drive and a powered unbalance mass is provided in vehicle seat elements.

It is known from DE 10 2016 211 718 A1 that motors in a massage device provided in a vehicle seat are controlled by a controller based on an acoustic maintenance signal.

It is known from DE 10 2017 220 184 A1 that an electromotive massage device of a power vehicle seat, which includes a massage drive with an electric motor, is controlled by means of the time derivative of an audio signal by generating a control signal for the electric motor by means of the time derivative and the electric motor is impinged herewith.

In addition to these massage systems, additional comfort functions for vehicles such as seat heaters, seat ventilation devices, interior lighting, sound systems and seat adjustment devices are known.

The disadvantage in the known methods for controlling the various comfort functions is the focusing on the respective comfort function, for example on the massage or the sound of the sound system or the interior lighting as such. The potential from the interaction of two or more different comfort functions that results when utilizing the respective possibilities of each comfort function is not utilized.

### SUMMARY

The task of the disclosure is to specify a new method to control two or more comfort functions of a vehicle by means of a controller and vehicle equipment to implement this method. In particular, the new method should utilize the potential that results from an interaction of two or more different comfort functions when the respective possibilities of each comfort function are utilized.

This task is solved, with regard to the method, by a method having the features discussed below and, with regard to the vehicle equipment, by a vehicle equipment having the features discussed below. Advantageous designs and further developments are specified in the corresponding dependent claims.

The method according to the disclosure for controlling one or more comfort functions of a vehicle by means of a controller initially provides that at least two or more of the following comfort functions be provided:
Pulsation massage by means of a pneumatic massage system of a vehicle seat that includes one or more air cushions and an air supply system for the individual air impingement of the air cushion(s),
Lumbar support by means of the pneumatic massage system,
Pelvic activation by means of the pneumatic massage system,
Lateral support adjustment by means of the pneumatic massage system,
Vibration by means of an electromechanical vibration system of the vehicle seat that includes one or more individually controllable electromechanical vibration devices,
Scenting by means of one or more scenting devices,
Air ionization by means of one or more ionization devices,
Seat ventilation by means of one or more ventilation devices, Seat heating by means of one or more heaters,
Air conditioning by means of the vehicle air conditioning unit of the vehicle and/or of the vehicle seat,
Humidity control by means of one or more humidity controllers of the vehicle,
Ambient lighting by means of the ambient lighting system of the vehicle,
Picture and/or video playback by means of one or more vehicle displays,
Sonication of the vehicle interior by means of a vehicle sound system,
Lighting of the vehicle interior by means of the vehicle interior lighting system,
Movement of at least partial areas of the vehicle seat by means of one or more vehicle seat adjusters.

The method according to the disclosure comprises the following method steps:
Analysis of the provided comfort functions and provision of a total control file for the provided comfort functions,
Orchestration of the total control file for controlling the provided comfort functions, in that starting from the analysis of the provided comfort functions, individual control signals are generated for each comfort function, and
Synchronized transmission of the individual control signals to the respective comfort functions, whereby each comfort function is controlled by the assigned individual control signal.

In particular, in the analysis and orchestration as well in the generation of the individual control signals, the respective other individual control signal(s) can be taken into account, so that the control of all provided comfort functions takes place by means of the individual control signals in a coordinated and/or supplementary way.

Orchestration is understood to be the assignment of the total control file to individual instruments, here specifically the provided comfort functions. This method can also be described as instrumentation. After the orchestration, the individual instruments, here the comfort functions, can run the program available as total control file together, specifically through synchronized transmission of the control signals generated in the orchestration.

The comfort functions are preferably intended for increasing the comfort and/or the well-being and/or the relaxation and/or the attention and/or the safety of at least one vehicle occupant.

As result of the orchestration, the most varied effects or impressions of a vehicle occupant can be created in a combined way, for example. For instance, in addition to general massage and/or vibration, special effects (e.g., activation) in the lumbar and/or pelvic region can be elicited. The lateral support of a seated vehicle occupant can also be included such as light effects, heat/cold (can be influenced via an air conditioning unit of the vehicle and/or via a seat air conditioning) and smells. Even the music can be played, if necessary in an adapted fashion, with regard to the volume and/or the controlled loudspeakers, for example.

Pulsation massage is understood to be, in particular, a massage in which a low-frequency vibration of the filled air cushions is elicited. Such a low-frequency vibration lies, for example, within the range of 0.5 Hz to 1000 Hz, especially between 1 Hz and 100 Hz, preferably below 70 Hz. Typical frequencies lie between 1 Hz and 20 Hz. This is made possible, for example, by a vibration generator arranged between the air supply system and air cushion that is fluidically connected to the air cushion in order to impinge the filled air cushion with a pressure vibration. Once the air cushion is filled with the desired filling volume, the pressure vibration can be generated exclusively via the vibration generator. In a vehicle seat, this pulsation can be restricted to certain air cushions, for example, and thus to certain areas of the vehicle seat, taking place for example only with air cushions arranged in a middle area of a backrest and/or of a seat cushion of the vehicle seat.

The air cushions of the massage system can be arranged in various positions of the vehicle seat such as in the back rest and in the seat cushion and carry out the respective various functions. For example, several air cushions in the back rest can be arranged to the left and right of the spine of a vehicle occupant, for instance in the shoulder region, breast region and lumbar region. Likewise, several air cushions can be arranged in the seat cushion. Air cushions can also be arranged in the lateral areas of the back rest and/or the seat cushion. Through individual, coordinated control, i.e., air impingement of the air cushions by means of the air supply system, different effects and/or actions can be elicited in a vehicle occupant sitting on a seat, for instance a massage effect by stimulation of certain muscles and/or mobilization of the back, especially the spine, in order to counteract tensions and signs of fatigue, thereby leading to an increase in comfort. A lumbar support and/or a lateral support of a vehicle occupant seated on the seat can also be brought about or changed during the control.

Analogously, the electromechanical vibration devices of the vibration systems can also be arranged in various places of the vehicle seat and elicit various effects and/or actions in a vehicle occupant through individual, coordinated control.

Consequently, the individual controllability of several air cushions and/or several vibration devices in the orchestration of the total control file and the generation of the individual control signals for the massage system or vibration system can be taken into account.

An embodiment provides that the air cushions of the pneumatic massage system be arranged only in the area of an A-surface of the vehicle seat, whereby an A-surface is a surface of the vehicle seat facing the vehicle occupant. An embodiment of the disclosure can also provide that the vibration devices be installed in the foam or upholstery of the vehicle seat and/or be arranged on a rear suspension in the vehicle seat.

The controller can be provided as an independent controller in addition to other controllers of the vehicle and having several parts if necessary. However, it is also possible for the controller to be the central controller of the vehicle, i.e., the central computer of the vehicle, upgraded by means of a respective software to implement the steps provided according to the disclosure that are explained below and/or to control the various comfort functions. The individual comfort functions comprise then at least essentially only the hardware, for example actuators, their control and the processing of all data then takes place in the central controller of the vehicle. Only the driver units to move the actuators can be provided in the hardware of the comfort functions if necessary.

Thus, a key advantage of the method according to the disclosure lies in the interaction of the comfort functions resulting from the orchestration. This allows a tailored and therefore integral effect of the comfort functions on the vehicle occupant(s), thereby leading, for example, to an integrated and harmonious massage experience, that possibly—and apart from feeling or sensing the massage—also includes additional senses of the vehicle occupant(s) such as the senses of hearing and/or seeing and/or smelling. Hence, the method according to the disclosure takes advantage of the potential resulting from the interaction of two or more different comfort functions utilizing the respective possibilities of each comfort function.

Another advantage resulting from the interaction of the comfort functions is the variety for the vehicle occupant(s). Previous comfort functions, especially those based on massage systems, operate only for themselves. This leads to a habituation effect for the vehicle occupant(s) because the programs being executed become known after being used a certain time. By integrating several comfort functions and/or the corresponding devices to provide these comfort functions, especially those of many and/or diverse actuators in the vehicle, for example in the vehicle seat, the possibilities provided for analyzing the audio or video file multiply, from which then a total control file can be provided through the method according to the disclosure, particularly owing to an intelligent logic stored in the controller. This total control file is then transmitted in a synchronized way to the corresponding comfort functions, especially to the equipment to provide these comfort functions, for example likewise by the intelligent logic stored in the controller, orchestrated for the individual control of the provided comfort functions by means of individual control signals generated here for each comfort function.

A further development provides that in the analysis of the provided comfort functions and the provision of a total control file, a provided audio or video file is taken into account.

The provided audio or video file can be a music piece. In this case, the instruments or instrument groups involved in the music piece can be taken into account in the analysis and orchestration, and in the orchestration of a first provided comfort function a first instrument or a first instrument group, and of a second provided comfort function a second instrument or a second instrument group are assigned, and the individual control signal of the respective comfort function coming from the part of the audio or video file that found consideration in the total control file is generated that pertains in each case to the corresponding assigned instrument or the assigned instrument group. For example, it can be a pneumatic massage system in the first comfort function, and an electromechanical vibration system and/or a sound system of the vehicle in the second comfort function.

Properties of the music piece such as the music genre and/or the dynamism and/or the pace and/or the expression and/or the way it is played can also be taken into account in the analysis and orchestration. The properties of the music piece to be considered in the analysis and orchestration of the music piece can be taken from external sources and/or from a database stored in or for the controller and/or from the audio or video file itself or from files assigned to the audio or video file. Thus, in the analysis of the audio or video file, not only self-obtained data and information can be taken into account, but already available information about properties of the music piece can be used. External sources can be contacted via an internet connection. External sources that can be taken into consideration are streaming services or music databases, for example.

An embodiment of the method according to the disclosure provides that in the analysis and orchestration the properties of the provided comfort functions are taken into account.

For example, the feasible pulsation frequencies of the pneumatic massage system can be taken into account as property of the pneumatic massage system and/or the feasible vibration frequencies of the electromechanical vibration devices as property of the electromechanical vibration system. It can also be taken into account that the feasible pulse frequencies of the pneumatic massage system are lower than the feasible vibration frequencies of the electromechanical vibration devices. Thus, the pneumatic massage system and the electromechanical vibration devices supplement one another with regard to the feasible frequencies.

The feasible frequency of the pneumatic massage by air cushions is, for example, 0.5 to 4 Hz, possibly also up to 15 Hz. The feasible frequencies of the electromechanical vibration devices can be between 5 and 20 Hz, possibly also up to 50 Hz.

For example, owing to the comparatively low feasibility of the massage system, frequencies of the first comfort function by a low-frequency coordinated control of the individual air cushions adapted to the audio or video file, an appropriate backgrounds experience can be elicited in the vehicle occupant, whereas fast and loud parts can be very easily implemented by the vibration system of the second comfort function.

The low-frequency pulsation of the massage system can thus create a framework for the music and/or the vibration system controlled by a high frequency and the resulting effect it evokes on the vehicle occupant. The combination leads then to a holistic experience or perception and thus evokes the corresponding mood in the vehicle occupant. The adaptation of the low-frequency pulsation of the massage system when the control signals to the audio or video file are generated can take place in such a way, for example, that the pulsation takes place according to the mood of the respective audio or video file music, fast or slow, soothing, or vitalizing, and is therefore adapted to the respective music. In fast music, a fast pulsation massage can take place, for example, in slow music, a corresponding slow massage.

A further development provides that to implement one or several comfort functions, a pneumatic massage system of a vehicle seat is provided that includes several air cushions and one air supply system, for the individual air impingement of the air cushions, whereby during the generation of the control signal for the comfort function or the comfort functions, the individual controllability of several air cushions of the massage system and/or the arrangement and distribution of the air cushions of the massage system in the vehicle seat is taken into account.

The pneumatic massage system can have between the air supply system and the air cushions one or several vibration generators fluidically connected to the air cushions that impinge the air cushions with a pressure vibration. In this case, when the control signal is generated, it is not only possible to take the individual controllability of several air cushions into account, but also that the air cushions formed accordingly can be influenced via the air supply system and via the vibration generator and are consequently separately controllable through the control file with regard to both aspects. In this way, it is possible to superimpose, for example, a lower main pulsation frequency that comes from the air supply system with a higher secondary pulsation frequency that comes from the vibration generator, whereby the amplitude of the amplitude of the main pulsation frequency is typically larger than the amplitude of the secondary pulsation frequency.

In particular, an individual vibration generator can be assigned to each air cushion. Each vibration generator can include an air chamber with varying volume and a drive element for changing the volume in the air chamber, whereby the air chamber is connected to the assigned air cushions.

According to an embodiment, a type of massage selected by a vehicle occupant can be taken into account in the analysis and orchestration.

It can also be provided that a vehicle occupant selects a type of massage by means of an input device and by using this selection, the controller selects a music piece or a playlist or suggests one to the vehicle occupant from a selection and the music piece or a music piece of the selected playlist is provided as audio or video file for the analysis and orchestration of the total control file.

A further development provides that to implement one or several comfort functions, an electromechanical vibration system of a vehicle seat that includes several individually controllable electromechanical vibration devices is made available. In this case, when the control signal for the comfort function(s) is generated, the individual controllability of several electromechanical vibration devices is taken into account.

For example, air cushions and/or vibration devices can be arranged in various areas of the back rest, in the vehicle surface and/or in the lateral supports of the seat and be individually controlled via the control signal of the first comfort function or of the second comfort function. The electromechanical vibration devices can generate audible and perceptible vibrations for the vehicle occupant.

It can furthermore be provided for the vehicle seat to have several surface areas in which at least one air cushion of the pneumatic massage system and/or at least one electromechanical vibration device of the vibration system is assigned. If the provided audio or video file is a music piece then in the analysis and orchestration different instruments or instrument groups or frequencies involved in the music piece are taken into account by assigning in the orchestration the air cushion(s) and/or the electromechanical vibration device(s) of a surface area another instrument or another instrument group or another frequency than that of the air cushion(s) and/or of the electromechanical vibration device(s) of another surface area. When the individual control signal of the respective comfort function is generated, then the individual control of the air cushions and/or of the electromechanical vibration devices of the various surface areas are taken into account in such a way that the generated control signals include this individual control.

As a result of this, the different instruments or instrument groups or frequencies of a music piece can be reproduced over the surface of the vehicle seat in a distributed way, for example split up on the front side of the back rest, the seat surface and/or the respective lateral surfaces. Reproduced is understood here to be especially the corresponding inflating and venting of the air cushions or the corresponding vibration of the vibration devices. For example, the massage effect of the different surface areas of the seat can be spatially split up in this way, for example by assigning the various instruments or instrument groups or frequencies.

The electromechanical vibration devices can in each case include a vibration generator and a carrier part connected to the vibration generator, on which the mechanical vibrations generated by the vibration generator are transferred. The carrier part can be especially a carrier plate.

According to an embodiment, individually entered wishes of a vehicle occupant or those selected from a given selection can be taken into account in the analysis and orchestration.

Also, in the analysis and orchestration, the data of the vehicle occupant pertaining, for example, to his/her condition and/or mood can be taken into account, that are transmitted to the controller via an internet or wireless connection from an electronic device that records the vehicle occupant data. For example, mobile device or smart watch data (e.g., calendar information about past or upcoming appointments, workout data, pulse data and/or stress level data) can be transmitted and taken into account by the controller in the analysis and orchestration.

If, for example, the future vehicle occupant approaches or enters the vehicle, his/her condition and/or his/her mood can be recorded, as exemplarily described above, and a music piece and/or a type of massage be offered from the selection.

An exemplary situation is a break during a journey to charge an electric vehicle, for example. Then, in the analysis and orchestration, through the corresponding input and/or selection by the vehicle occupant and/or through the respective data evaluation, the expected duration of the break and/or the target position of the vehicle occupant for the break, such as relaxation and/or a power nap, can be taken into account. The vehicle occupant is then relaxed for as long as this break lasts, which can be the charging duration of the electric vehicle, by means of comfort functions by heating or venting the vehicle seat, for example, and/or the right program combining music, massage and/or lighting runs. Here, if necessary, a power nap of the vehicle occupant can also be supported. For example, the comfort functions can be controlled in such a way that massage and/or music become more invigorating towards the end of the break and/or the temperature of the vehicle seat is lowered through venting, for example, resulting in the reawakening of the vehicle occupant.

Furthermore, surrounding noises outside and/or inside the vehicle and/or the surrounding brightness can be taken into account in the analysis and orchestration. For example, in the analysis and orchestration, the controller can take into account that surrounding noises outside and/or inside the vehicle are possibly compensated. Moreover, the surrounding brightness, such as sunshine and/or cloudy weather and/or daylight and/or nocturnal darkness, can be taken into account in the analysis and orchestration.

A further development provides that a vehicle occupant selects a music piece or a playlist by means of an input device of the controller and the selected music piece or a music piece from the selected playlist is made available as audio or video file for the analysis and orchestration of the total control file. Generally, the music pieces are already fully available in the selection, so that the analysis can take place immediately and thus almost directly after the selection, at least within a few seconds, the orchestration is implemented and consequently the massage and/or vibration adapted to the audio or video file can take place, for example.

The vehicle equipment according to the disclosure exists to implement the method according to the disclosure. This method is intended for controlling two or more comfort functions of a vehicle. The vehicle equipment includes one controller and has at least one of the following systems or devices for providing the comfort functions:
a pneumatic massage system of a vehicle seat that includes one or more air cushions and an air supply system for the individual air impingement of the air cushion(s),
an electromechanical vibration system of a vehicle seat independent from the pneumatic massage system that includes one or more individually controllable electromechanical vibration devices,
one or more scenting devices,
one or more ionization devices,
one or more ventilation devices,
one or more heaters for heating the seat,
an air conditioning unit of the vehicle and/or vehicle seat,
one or more humidity controllers of the vehicle,
an ambient lighting system of the vehicle and/or
one or more displays for image display and/or video playback,
a sound system of the vehicle,
a vehicle interior lighting system,
one or more vehicle seat adjusters for moving at least some areas of the vehicle seat.

The controller is set up to analyze a provided audio or video file and provide a total control file for the provided comfort functions, to orchestrate the total control file for controlling the provided comfort functions by generating, starting from the analysis of the provided comfort functions, individual control signals for each comfort function, and to transmit the individual control signals to the corresponding comfort functions in a synchronized way, whereby each comfort function is controlled by the assigned individual control signal.

Preferably, in the analysis, orchestration and generation of the individual control signals, the controller is moreover set up to take into account the or the other individual control signals so that the control of all provided comfort functions by means of the individual control signals takes place in coordinated and/or supplementary way.

The vehicle equipment can include an input device for a vehicle occupant with which the vehicle occupant can select, for example, a music piece and/or a type of massage. In the first-mentioned case, the controller can select a massage and/or vibration program adapted to the music piece or suggest a selection to the vehicle occupant and then take the selected program into account in the analysis and orchestration. In the latter case, using the selection, the controller can select a music piece or a playlist or suggest a selection to the vehicle occupant and provide the selected music piece or a music piece from the selected playlist as audio or video file for the analysis and orchestration.

The electromechanical vibration devices can in each case include a vibration generator and a carrier part connected to the vibration generator onto which the mechanical vibrations generated by the vibration generator are transmitted. The carrier part can be especially a carrier plate.

The pneumatic massage system can have between the air supply system and the air cushion(s) at least one vibration generator fluidically connected to the air cushion(s) that impinges a pressure vibration onto the air cushion(s). In particular, an individual vibration generator can be assigned to each air cushion. Each vibration generator can include an air chamber with varying volume and a drive element to change the volume in the air chamber, whereby the air chamber is connected to the assigned air cushion.

### BRIEF DESCRIPTION OF THE DRAWINGS

The disclosure will be explained in more detail below, also with regard to additional features and advantages by describing an embodiment and with reference to the enclosed schematic drawing.

FIG. 1 is a schematic representation of an example of a vehicle equipment according to the disclosure to implement an embodiment of a method according to the disclosure.

### DETAILED DESCRIPTION

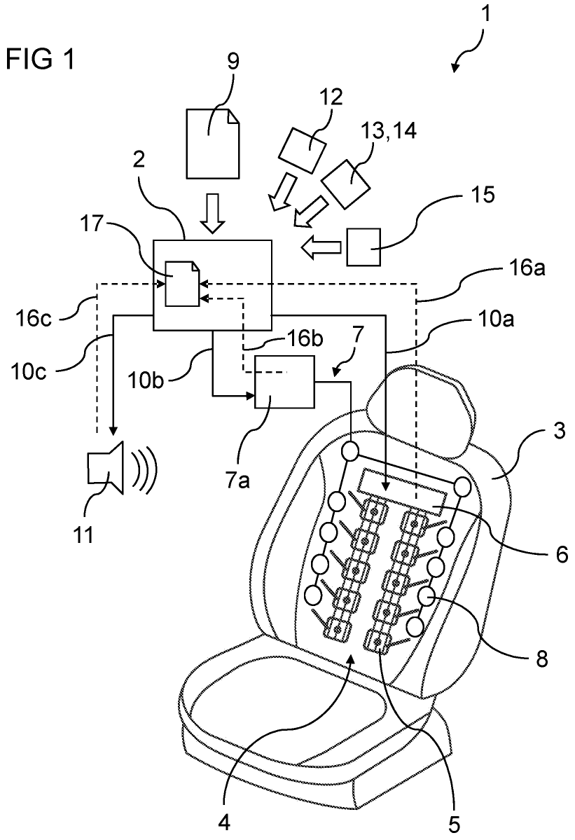

FIG. 1 shows a vehicle equipment 1 to implement an embodiment of a method according to the disclosure. This method is intended for controlling two or more comfort functions of a vehicle. To do this, the vehicle equipment 1 includes a controller 2 set up accordingly and a vehicle seat 3.

The vehicle seat 3 has a pneumatic massage system 4 to provide a first comfort function. The massage system 4 includes several air cushions 5 and one air supply system 6 for the individual air impingement of the air cushions 5.

In addition, the vehicle seat 3 has an electromechanical vibration system 7 independent from the pneumatic massage system 4 to provide a second comfort function that includes several electromechanical vibration devices 8 individually controllable by a controller 7a of the vibration system 7.

Furthermore, the vehicle equipment includes a sound system 11 as an example of a third comfort function.

The controller 2 is set up to analyze the provided comfort functions, in the example shown especially the pneumatic massage system 4, the electromechanical vibration system 7 and the sound system 11 and, based on this analysis, provide a total control file for the provided comfort functions, in FIG. 17 symbolized by the file symbol with the reference character 17 inside the controller 2. In the example shown, the analysis of the pneumatic massage system 4 as first comfort function is symbolically indicated by the first dotted arrow 16a, the analysis of the electromechanical vibration systems 7 as second comfort function by the second dotted arrow 16b and the analysis of the sound system 11 as third comfort function by the third dotted arrow 16c.

Moreover, the controller 2 is set up to orchestrate the total control file 17 for controlling the provided comfort functions by generating individual control signals for each comfort function starting from the analysis of the provided comfort functions, and the individual control signals are transmitted to the respective comfort functions in a synchronized way, whereby each comfort function is controlled by the assigned individual control signal. In the example shown, the pneumatic massage system 4 as first comfort function is controlled by a first control signal 10, the electromechanical vibration system 7 as second comfort function by a second control signal 10b, and the sound system 11 as third comfort function by a third control signal 10c.

In the analysis of the provided comfort functions and the provision of a total control file by the controller 2, a provided audio or video file 9 is also taken into account in the example shown. The data 12 of a vehicle occupant that the controller 2 transmits, for example, via an internet or wireless connection from an electronic device that records the vehicle occupant data can also be taken into account. Furthermore, surrounding noises 13 and/or the surrounding brightness 14 can be taken into account as shown schematically in FIG. 1.

FIG. 1 shows the provision of an input device 15 of the controller 2. By means of this input device 2, a vehicle occupant can select a music piece or a playlist, for example. The selected music piece or a music piece from the selected playlist is then provided as audio or video file 9 for the analysis and orchestration by the controller 2. Alternatively or additionally, the vehicle occupant can also select a type of massage of the massage system 4 and/or a vibration pattern of the vibration system 7 by means of the input device 15. Using this selection, the controller 2 selects a music piece or a playlist or suggests a music piece or a playlist to the vehicle occupant from the selection. The selected music piece or a music piece from the selected playlist is then provided as audio or video file 9 for the analysis and orchestration by the controller 2.

### LIST OF REFERENCE CHARACTERS

1 Vehicle equipment
2 Controller
3 Vehicle seat
4 Pneumatic massage system as first comfort function
5 Air cushion
6 Air supply system
7 Electromechanical vibration system as second comfort function
7a Controller of the vibration system 7
8 Electromechanical vibration devices
9 Audio or video file
10a First control signal
10b Second control signal
10c Third control signal
11 Sound system as third comfort function
12 Vehicle occupant data
13 Surrounding noises
14 Surrounding brightness
15 Input device
16a Analysis of the first comfort function
16b Analysis of the second comfort function
16c Analysis of the third comfort function
17 Total control file

1. A method for controlling two or more comfort functions of a vehicle using a controller, wherein a first comfort function is provided by a pneumatic massage system of a vehicle seat including one or more air cushions and an air supply system for the individual air impingement of the one or more air cushions, and wherein a second comfort function is provided by an electromechanical vibration system of the vehicle seat independent from the pneumatic massage system and including one or more individually controllable electromechanical vibration devices, the method comprising the following steps:
analyzing a provided audio or video file taking the provided comfort functions into account;
orchestrating the audio or video file by generating individual control signals for each comfort function the audio or video file after the analyzing; and
synchronized transmitting the individual control signals to the corresponding comfort functions, whereby each comfort function is controlled by an individually assigned one of the individual control signals.

2. The method according to claim 1, wherein the provided audio or video file is a music piece and the instruments or instrument groups involved are taken into account in the analysis and orchestration, and in the orchestration of the first comfort function, a first instrument or a first instrument group, and of the second comfort function a second instrument or second instrument group are assigned, and the individual control signal of the respective comfort function is generated starting from the part of the audio or video file that pertains to the instrument assigned in each case or the instrument group assigned in each case.

3. The method according to claim 2, wherein the properties of the music piece are taken into account in the analysis and orchestration.

4. The method according to claim 3, wherein the music genre and/or the dynamism and/or the pace and/or the expression and/or the way it is played are taken into account as properties of the music piece.

5. The method according to claim 3, wherein the properties of the music piece to be taken into account for the analysis and orchestration are taken from external sources and/or from a database stored in or for the controller and/or from the audio or video file itself or from files assigned to the audio or video file.

6. The method according to claim 1, wherein in the analysis, orchestration and generation of the individual control signals, the control signal or the respective other individual control signals are taken into account, so that the control of all provided comfort functions using the individual control signals takes place in a coordinated and/or complementary way.

7. The method according to claim 1, wherein the properties of the provided comfort functions are taken into account in the analysis and orchestration.

8. The method according to claim 7, wherein feasible pulsation frequencies of the pneumatic massage system are taken into account as a property of the first comfort function, and/or feasible vibration frequencies of the electromechanical vibration devices as a property of the second comfort function.

9. The method according to claim 8, wherein it is taken into account that the feasible pulse frequencies of the pneumatic massage system are lower than the feasible vibration frequencies of the electromechanical vibration devices.

10. The method according to claim 1, wherein in the generation of the control signal for the first comfort function, an individually controllability of several air cushions of the massage system and/or an arrangement and distribution of the air cushions of the massage system in the vehicle seat is taken into account; and/or
in the generation of the control signal for the second comfort function individual controllability of several electromechanical vibration devices of the vibration system is taken into account.

11. The method according to claim 10, wherein the vehicle seat has several surface areas to which in each case at least one air cushion of the massage system and/or at least one electromechanical vibration device of the vibration system is assigned;
the provided audio or video file is a music piece and in the analysis and orchestration various instruments or instrument groups or frequencies involved in the music piece are taken into account, in that in the orchestration another instrument or another instrument group or another frequency is assigned to the air cushion(s) and/or the electromechanical vibration device(s) of a surface area than that of the air cushions(s) and/or the electromechanical vibration device(s) of another surface area; and
in the generation of the control signal for the first comfort function and/or in the generation of the control signal for the second comfort function the individual control of the air cushions and/or of the electromechanical vibration devices of the various surface areas is taken into account in such a way that the generated control signals include this individual control.

12. The method according to claim 1, wherein individually entered wishes of a vehicle occupant or those selected from a given selection are taken into account in the analysis and orchestration.

13. The method according to claim 1, wherein a type of massage selected by a vehicle occupant is taken into account in the analysis and orchestration.

14. The method according to claim 1, wherein vehicle occupant data transmitted to the controller via an internet or a wireless connection from an electronic device that records the vehicle occupant data are taken into account in the analysis and orchestration.

15. The method according to claim 1, wherein surrounding noises outside and/or inside the vehicle and/or surrounding brightness are taken into account in the analysis and orchestration.

16. The method according to claim 1, wherein a vehicle occupant selects a music piece or a playlist using an input device of the controller and the selected music piece or a music piece from the selected playlist is provided as audio or video file for the analysis and orchestration.

17. The method according to claim 1, wherein using an input device, a vehicle occupant selects a type of massage of the first comfort function and/or a vibration pattern of the second comfort function and using this selection, the controller selects a music piece or a playlist or suggests one to the vehicle occupant from the selection and the selected music piece or a music piece of the selected playlist is provided as audio or video file for the analysis and orchestration.

18. The method according to claim 1, wherein the electromechanical vibration devices include in each case one vibration generator and one carrier part connected to the vibration generator on which the mechanical vibrations generated by the vibration generator are transferred.

19. The method according to claim 1, wherein the electromechanical vibration devices generate audible and perceptible vibrations for the vehicle occupant.

20. The method according to claim 1, wherein the pneumatic massage system has at least one vibration generator between the air supply system and the air cushion(s) that is fluidically connected to the air cushion(s) that supplies the air cushion(s) with a pressure vibration.

21. The method according to claim 20, wherein an individual vibration generator is assigned to each air cushion.

22. The method according to claim 20, wherein each vibration generator includes one air chamber with varying volume and a drive element for changing the volume in the air chamber, whereby the air chamber is connected to the assigned air cushion.

23. The method according to claim 1, wherein apart from the first comfort function and the second comfort function, one or more additional comfort functions are provided and taken into account in the analysis and orchestration of the audio or video file and controlled here by individually generated control signals.

24. The method according to claim 23, wherein the additional comfort functions to increase the comfort and/or well-being and/or relaxation and/or attention and/or safety are intended for at least one vehicle occupant.

25. The method according to claim 23, wherein the following are provided as additional comfort functions:
scenting using one or more scenting device; and/or
air ionization using one or more ionization devices; and/or
seat ventilation using one or more ventilation devices; and/or
seat heating using one or more heaters; and/or
air conditioning using the air conditioning unit of the vehicle and/or of the vehicle seat; and/or
humidity control using one or more humidity controllers of the vehicle; and/or
ambient lighting using the ambient lighting system of the vehicle; and/or
picture and/or video playback using one or more displays of the vehicle; and/or
sonication of the vehicle interior using a sound system of the vehicle; and/or
lighting of the vehicle interior using the vehicle interior lighting system; and/or
movement of at least some areas of the vehicle seat using one or more vehicle seat adjusters.

26. Vehicle equipment to carry out the method according to claim 1,
wherein the method controls two or more comfort functions of a vehicle;
wherein the vehicle equipment includes one controller and at least one vehicle seat;
wherein the vehicle seat has a pneumatic massage system to provide a first comfort function that includes one or more air cushions and one air supply system for the individual air impingement of the air cushion(s);
wherein the vehicle seat has an electromechanical vibration system independent from the pneumatic massage system to provide a second comfort function that includes one or more individually controllable electromechanical vibration devices; and
wherein the controller is configured to:
analyze a provided audio or video file taking the provided comfort functions into account;
orchestrate the audio or video file by generating individual control signals for each comfort function, starting from the audio or video file and its analysis; and
transmit the individual control signals to the corresponding comfort functions in a synchronized way, wherein each comfort function is controlled by the assigned individual control signal.
